(19) United States
(12) Patent Application Publication
(10) Pub. No.: US 2021/0108086 A1
(43) Pub. Date: Apr. 15, 2021

(54) DISPLAY APPARATUS AND MANUFACTURING METHOD THEREOF

(71) Applicant: SAMSUNG ELECTRONICS CO., LTD., Suwon-si, Gyeonggi-do (KR)

(72) Inventors: Jin Soo KIM, Suwon-si (KR); You Jin CHOI, Suwon-si (KR)

(73) Assignee: SAMSUNG ELECTRONICS CO., LTD., Suwon-si, Gyeonggi-do (KR)

(21) Appl. No.: 16/958,832

(22) PCT Filed: Dec. 21, 2018
(86) PCT No.: PCT/KR2018/016538

§ 371 Date: Jun. 29, 2020

(30) Foreign Application Priority Data
Jan. 3, 2018 (KR) 10-2018-0000805

(51) Int. Cl. C09D 1/00; H05K 5/00; C09D 175/04; C09D 167/00; C09D 163/00; C09D 133/00

(52) U.S. Cl. CPC C09D 1/00; H05K 5/0017; C09D 175/04; G02F 1/133317; C09D 163/00; C09D 133/00; C09D 167/00

(57) ABSTRACT

The disclosed embodiment relates to a display apparatus that improves the coating method of a display apparatus and a manufacturing method thereof. In accordance with one aspect of the disclosure, a display apparatus includes a display panel configured to display an image and a frame coupled to surround the outside of the display panel, and the frame includes a base member, an upper coating layer coated on the upper part of the base member, a lower coating layer coated on the lower surface of the base member. According to the disclosed embodiment, cracks can be prevented from occurring during slitting, and excessive camber and twisting can be prevented.

### TECHNICAL FIELD

The present disclosure relates to a display apparatus and a manufacturing method thereof, and more particularly, to a display apparatus which have improved the coating method of the display apparatus, and a manufacturing method thereof.

### BACKGROUND ART

In general, a display apparatus is a apparatus that displays a screen, and includes a monitor or a television.

The display panel includes a self-emissive display panel and a non-emissive display panel. The self-emissive display panel includes a Cathode Ray Tube (CRT) panel, an Electro Luminescence (EL) panel, an Organic Light Emitting Diode (OLED) panel, a Vacuum Fluorescence Display (VFD) panel, a Field Emission Display (FED) panel, a Plasma Display Panel (PDP) panel, etc., and the non-emissive display panel includes a Liquid Crystal Display (LCD) panel.

The LCD panel includes a back light unit to emit white light, and a display panel to transmit or block light emitted from the back light unit.

When coating the display apparatus, a polyester-based paint was mainly used, but it lacked gloss and clarity compared to an acrylic-based paint. In addition, a camber occurred during slitting.

### DISCLOSURE

Therefore, it is an aspect of the disclosure to provide a display apparatus which may prevent crack and camber of a coating film, and a manufacturing method thereof.

In accordance with one aspect of the disclosure, a display apparatus includes: a display panel configured to display an image; and a frame coupled to surround the outside of the display panel, and the frame includes: a base member; an upper coating layer coated on the upper part of the base member; a lower coating layer coated on the lower surface of the base member.

The frame may further include a primer layer provided between the base member and the upper coating layer.

The frame may further include a pre-treatment layer provided between the base member and the primer layer.

The friction coefficient of the lower coating layer may be less than 0.3.

The upper coating layer may be acrylic.

The lower coating layer may be at least one selected from a group of acrylic resin, epoxy, polyester, and urethane.

The pre-treatment layer may be at least one selected from a group of silicon oxide (SiO₂), zirconium oxide (ZrO₂), and chromium containing coating.

The base member may be at least one selected from a group of stainless steel, aluminum, and metallic coated metal.

The metallic coated metal may be at least one selected from a group of zinc (Zn), zinc-nickel (Zn—Ni), nickel (Ni), aluminum (Al), tin (Sn), and tin-zinc (Sn—Zn).

The frame may be a middle front coupled to surround the lower outer surface of the display panel.

In accordance with another aspect of the disclosure, a manufacturing method of a display apparatus including a display panel configured to display an image, a frame provided on the outside of the display panel, the manufacturing method includes: coating an upper coating layer and a lower coating layer on the upper part and lower part of a base member; slitting to cut the coated base member at predetermined intervals; painting the cut surface of the base member on which slitting was performed; drying the base member.

The coating may include coating a pre-treatment layer on the upper surface of the base member, coating a primer layer on the upper surface of the pre-treatment layer, coating the upper coating layer on the upper surface of the primer layer and coating the lower coating layer on the lower surface of the base member.

The upper coating layer and the lower coating layer may be coated at the same time.

The friction coefficient of the lower coating layer may be less than 0.3.

According to the display apparatus and manufacturing method thereof according to the disclosed embodiment, it is possible to prevent cracking and peeling of the coating film occurring during slitting.

Also, the range of camber and twisting can be reduced.

### DESCRIPTION OF DRAWINGS

FIG. 1 is a view illustrating a display apparatus according to an embodiment disclosed.

FIG. 2 is an exploded view illustrating an exploded display apparatus according to an embodiment disclosed.

FIG. 3 is a view illustrating a coating layer of a frame of a display apparatus according to an embodiment disclosed.

FIG. 4 is a view illustrating a process of coating of a frame according to an embodiment disclosed.

FIG. 5 is a photograph showing whether cracks are generated according to temperatures according to the disclosed embodiments and comparative examples.

### MODE OF THE INVENTION

Configurations illustrated in the embodiments and the drawings described in the present specification are only the preferred embodiments of the present disclosure, and thus it is to be understood that various modified examples, which may replace the embodiments and the drawings described in the present specification, are possible when filing the present application.

In addition, the same reference numbers or symbols provided in each drawing of the present specification denote parts or components that perform substantially the same function.

The terms used in the present specification are used to describe the embodiments of the present disclosure. Accordingly, it should be apparent to those skilled in the art that the following description of exemplary embodiments of the present invention is provided for illustration purpose only and not for the purpose of limiting the invention as defined by the appended claims and their equivalents. It is to be understood that the singular forms “a,” “an,” and “the” include plural referents unless the context clearly dictates otherwise. It will be understood that when the terms “includes,” “comprises,” “including,” and/or “comprising,” when used in this specification, specify the presence of stated features, figures, steps, components, or combination thereof, but do not preclude the presence or addition of one or more other features, figures, steps, components, members, or combinations thereof.

It will be understood that, although the terms first, second, etc. may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

Hereinafter, an embodiment of the present disclosure will be described in detail with reference to the appended drawings.

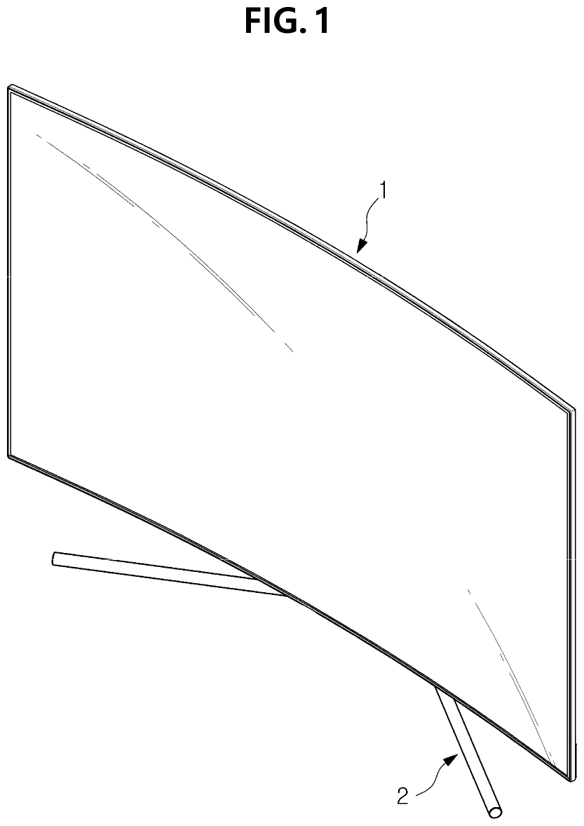

FIG. 1 is a view illustrating a display apparatus according to an embodiment disclosed.

As shown in FIG. 1, the display apparatus according to the disclosed embodiment includes a display unit 1 on which a screen is displayed and a stand 2 supporting the display unit 1. In one disclosed embodiment, the display unit 1 is formed in a curved shape in which both end portions protrude toward the front side, but is not limited thereto.

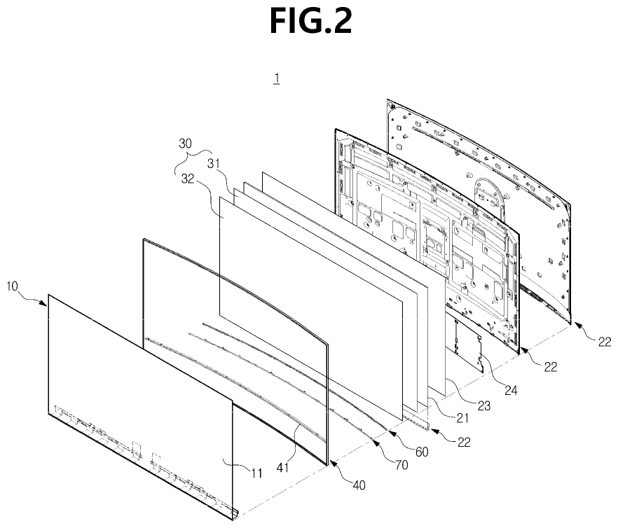

FIG. 2 is an exploded view illustrating an exploded display apparatus according to an embodiment disclosed.

As shown in FIG. 2, the display unit 1 includes a display panel module 10 including a display panel 11 on which a screen is displayed, a backlight 21, 22, 23 that is disposed behind the display panel 11 and supplies light to the display panel 11, a frame that is coupled to surround the outside of the display panel 11. The frame may include a frame case 40 surrounding the outer end of the display panel 11, a bottom chassis 50 for receiving and supporting the backlight 21, 22, 23, a middle mold 60 coupled to the outer side of the bottom chassis 50 to support the optical sheet 30, a rear case 80 installed to cover the rear side of the bottom chassis 50 to form the rear surface of the display unit 1.

The backlight 21, 22, 23 include a light guide plate 21 formed in a square plate shape, a light source 22 disposed opposite to the lower end of the light guide plate 21 to generate light, a white reflective sheet 23 disposed on the rear surface of the light guide plate 21 to reflect light. In addition, a heat dissipation panel 24 is disposed at a lower portion of the rear surface of the reflective sheet 23 to easily dissipate heat by diffusing the heat generated from the light source 22.

Optical sheets 30 include a diffuser sheet 31 for receiving and diffusing light emitted from the light guide plate 21 toward the front side, a Dual Brightness Enhancement Filim (DBEF) sheet 32, which is disposed on the front side of the diffuser sheet 31 and is a high-brightness prism sheet.

The frame case 40 is formed in a square ring shape, and supports the outside of the display panel 11 formed in a square plate shape. The frame case 40 may be formed to be bent such that both end portions protrude toward the front side.

In addition, the frame case 40 may further include a reinforcement member 41 coupled to the lower inner side.

The middle mold 60 is formed in a bar shape and is coupled to the lower portion of the bottom chassis 50. In addition, a middle front 70 supporting the lower portion of the display panel 11 may be coupled to the front of the middle mold 60. The middle front 70 is formed of a metal material and is formed to have a substantially L-shaped cross section, and a lower surface of the rear end of the display panel 11 is supported on the front surface. In this embodiment, the lower portion of rear surface of the display panel 11 is attached to the front surface of the middle front 70 through a double-sided tape T. In addition, the middle front 70 also serves to support the lower end of the optical sheets 30 together with the middle mold 60.

The bottom chassis 50 is formed in an approximately open front surface to accommodate the backlights 21, 22, and 23 therein. In this embodiment, the bottom chassis 50 is formed in a curved shape so that both end portions protrude toward the front side, and the light guide plate 21 is formed in a flat plate shape and is bent and deformed so that both ends thereof protrude toward the front side so as to correspond to the bottom chassis 50 in the process of being installed and supported in the bottom chassis 50.

In addition, although not shown on the drawing, various printed circuit boards for controlling the operation of the display apparatus are arranged on the rear surface of the bottom chassis 50. These printed circuit boards include a power supply board for supplying power to the display unit 1, a panel driving substrate driving the display panel 11, a timing control board for transmitting an image signal to the display panel 11 and a a signal processing board for processing image and sound signals.

The rear case 80 is installed to cover the rear side of the bottom chassis 50 to cover printed circuit boards installed on the rear surface of the bottom chassis 50.

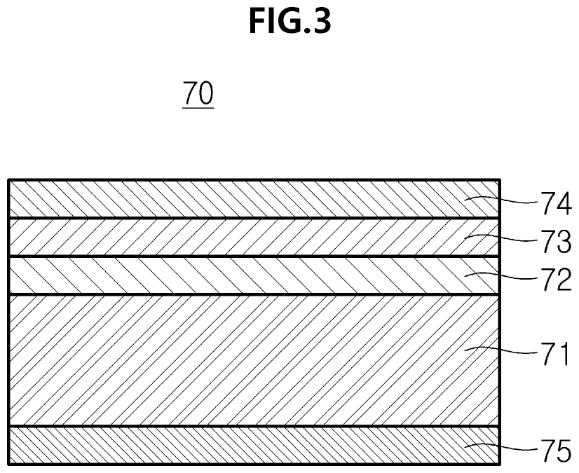

FIG. 3 is a view illustrating a coating layer of a frame of a display apparatus according to an embodiment disclosed. More specifically, the disclosed embodiment is a case where the coating layer is coated on the middle front 70, but is not limited thereto.

Coating of the frame of the disclosed embodiment is made in a Pre-Coated-Metal (PCM) method. That is, the side parts of the roll coating are coated for anti-corrosion treatment and color application, and slitting is performed. The PCM method consists of a base member and an organic coating layer. Various colors and patterns may be realized by applying a paint on the base member surface, heating it at a certain temperature, and curing it. In order to apply as an exterior material of the display apparatus, press processing is performed, and then slitting is performed to process a certain width. After slitting, the coating process is performed for anti-corrosion treatment and coloring of the surface of the uncoated base member.

The frame according to the disclosed embodiment includes a base member 71, an upper coating layer 74 coated on the upper portion of the base member 71, and a lower coating layer 75 coated on the lower surface of the base member 71. That is, the surface of the middle front 70 may be coated with a base member 71, an upper coating layer 74 may be coated on the upper portion of the base member, and a lower coating layer 75 may be coated on the lower surface of the base member 71.

In addition, the frame may further include a primer layer 73 provided between the base member 71 and the upper coating layer 74. In addition, the frame may further include a pre-treatment layer 72 provided between the base member 71 and the primer layer 73.

That is, a pre-treatment layer 72, a primer layer 73, and an upper coating layer 74 may be stacked on the upper surface of the base member 71 of the middle front 70. A lower coating layer 75 may be stacked on the lower surface of the base member 71 of the middle front 70.

The base member 71 may be at least one selected from the group of stainless steel, aluminum (Al), and metallic coated metal. These may be used individually, but may also be used in combination.

The metallic coated metal may be at least one selected from the group of zinc (Zn), zinc-nickel (Zn—Ni), nickel (Ni), aluminum (Al), tin (Sn), and tin-zinc (Sn—Zn). These may be used individually, but may also be used in combination. Roughness of metallic coated metal may be less than 30 μm.

The primer layer 73 is used to enhance the adhesion of the upper coating layer 74 to the base member 71.

The pre-treatment layer 72, like the primer layer 73, is used to enhance the adhesion of the upper coating layer 64 to the base member 71. As the pre-treatment layer 72, at least one selected from a group of silicon oxide (SiO₂), zirconium oxide (ZrO₂), and chromium containing coating may be used. These may be used individually, but may also be used in combination.

The upper coating layer 74 is a coating layer that realizes the color of the exterior. An acrylic based paint may be used as the upper coating layer 74. The upper coating layer 74 may have a thickness of 5 to 20 μm. In addition, the surface hardness of the upper coating layer 74 may be F to 4H.

The friction coefficient of the lower coating layer 75 may be adjusted by adding polyethylene-based waxes to the paint used as the lower coating layer 75 within the range of 0.01 to 2.5%. In this way, the lower coating layer 75 may optimize the friction coefficient of the rear surface of the base member 71 to prevent camber and twisting of the frame. The lower coating layer 75 may be at least one selected from the group of acrylic resin, epoxy, polyester, and urethane. These may be used individually, but may also be used in combination. The thickness of the lower coating layer 75 may be 1 to 5 μm. The friction coefficient of the lower coating layer 75 may be less than 0.3. Since the friction coefficient of the lower coating layer 75 is managed to be less than 0.3, it is possible to prevent excessive cambers during slitting and excessive cambers and twists during press.

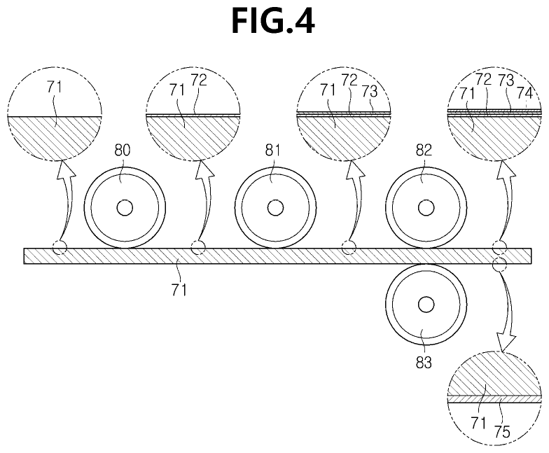

FIG. 4 is a view illustrating a process of coating of a frame according to an embodiment disclosed.

A manufacturing method of a display apparatus according to disclosed embodiment includes coating an upper coating layer 74 and a lower coating layer 75 on the upper part and lower part of a base member 71, slitting to cut the coated base member 71 at predetermined intervals, painting the cut surface of the base member 71 on which slitting was performed and drying the base member 71.

Coating of the frame according to one disclosed embodiment proceeds with roll coating. The coating proceeds in a manner that the rolls 80, 81, 82, and 83 proceed while the base member 71 is unfolded. The rolls 80, 81, 82, and 83 may include a first upper roll 80, a second upper roll 81, and a third upper roll 82. The lower coating layer 75 coated on the lower surface of the base member 71 may be coated by the lower roll 83.

The first upper roll 80 coats the pre-treatment layer 72. The second upper roll 81 coats the primer layer 73 on the pre-treatment layer 72. The third upper roll 82 coats the upper coating layer 74 on the primer layer 73. According to the disclosed embodiment, when the third upper roll 82 coats the upper coating layer 74, the lower roll 83 coats the lower coating layer 75. That is, the upper coating layer 74 and the lower coating layer 75 may be coated simultaneously. However, this is only one embodiment disclosed and is not limited thereto. The lower coating layer 75 may be coated together with the upper coating layer 74, depending on the process, the lower coating layer 75 may be coated together with a pre-treatment layer 72 or primer layer 73. This may be done by changing the position of the lower roll 83.

After the coating step, the base member 71 on which the coating has progressed may be wound up.

After the coating step, a slitting step in which the coated base member 71 is cut at predetermined intervals is performed. The slitting step is a step of cutting the coated base member 71 at 20 mm intervals. Since the thickness of the base member 71 is as thin as 0.15 T, during the slitting step, excessive camber or cracks occurred. According to one embodiment of the disclosure, since the friction coefficient of the lower coating layer 75 is adjusted to less than 0.3 in the coating step, it is possible to prevent excessive camber or cracks in the base member 71.

After the slitting step, painting is performed on the cut surface of the base member 71 that is not coated.

The base member 71, which has undergone painting, is dried.

Hereinafter, an experiment result in which crack occurrence and camber and twisting degree are measured for the display apparatus according to the disclosed embodiment will be described.

In order to measure the occurrence of cracks, slitting was performed at 30 to 60 MPM in the examples and comparative examples described below, and cemented carbide was used as the knife material. The curing temperature of the material surface is 232° C. Slitting was performed at 5° C., 10° C., 15° C., 20° C., and 25° C. to 20 mm for each comparative example and example in order to measure whether cracking occurred according to the slitting temperature.

In the case of the embodiment, water-dispersed silica was used as a pre-treatment layer in stainless steel (STS439), polyester was used as the primer layer, acrylic-based paint was used as the upper coating layer, and epoxy-based paint was used as the lower coating layer.

In the case of the comparative example, an acrylic-based paint was used as an upper coating layer on stainless steel (STS439), and the pre-treatment layer, primer layer, and lower coating layer were not included.

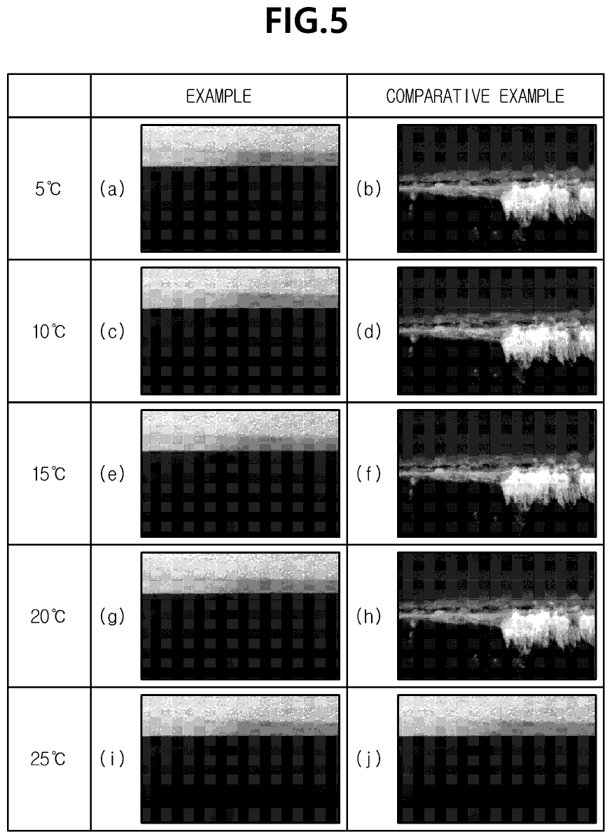

FIG. 5 is a photograph showing whether cracks are generated according to temperatures according to the disclosed embodiments and comparative examples.

As can be seen in FIG. 5, in the disclosed embodiment, it may be confirmed that cracks do not occur at 5 to 25° C. However, in the case of the comparative example, it may be confirmed that cracks were generated at 5 to 20° C. In the embodiment disclosed herein, it may be confirmed that slitting is possible regardless of temperature.

Hereinafter, for the measurement of camber and twisting degree, in the state of the friction coefficient of the lower coating layer of the above-described embodiment is 0.1 to 0.2, 0.2 to 0.3, 0.3, the camber when slitting from 615 mm to 20 mm and the camber and twisting degree when pressed from 20 mm to 6 mm were measured. The cambers during slitting were measured 5 times for each friction coefficient, and the cambers and twisting during press were measured 5 times for each friction coefficient. Slitting and pressing were conducted at room temperature. The camber during slitting and the camber and twisting during pressing are listed in [Table 1] below.

TABLE 1

| friction | slitting (615 mm→20 mm) | | | | | press(20 mm→6 mm) | | | | | | | | | |
|---|---|---|---|---|---|---|---|---|---|---|---|---|---|---|---|
| coefficient | camber | | | | | camber | | | | | twisting (unit: °) | | | | |
| 0.1~0.2 | 0.1 | 0.08 | 0.06 | 0.12 | 0.12 | 0.1 | 0.03 | 0.03 | 0.03 | 0.08 | 35 | 20 | 10 | 5 | 15 |
| 0.2~0.3 | 0.15 | 0.3 | 0.32 | 0.31 | 0.12 | 0.13 | 0.17 | 0.23 | 0.21 | 0.12 | 35 | 43 | 35 | 20 | 34 |
| 0.3 | 0.45 | 0.6 | 0.3 | 0.7 | 0.21 | 0.3 | 0.45 | 0.56 | 0.57 | 0.47 | 50 | 60 | 45 | 50 | 35 |

As can be seen in Table 1, when the friction coefficient is 0.3, it may be seen that the camber during slitting and during pressing is significantly increased. When the friction coefficient of the lower coating layer 75 is less than 0.3 according to one disclosed embodiment, the camber during press may be managed to less than 0.5 mm. In addition, in the case of twisting, when the friction coefficient of the lower coating layer 75 is less than 0.3 according to the disclosed embodiment, it may be managed within 45°.

Although a few embodiments of the present disclosure have been shown and described, it would be appreciated by those skilled in the art that changes may be made in these embodiments without departing from the principles and spirit of the disclosure, the scope of which is defined in the claims and their equivalents.

1. A display apparatus comprising:
a display panel configured to display an image; and
a frame coupled to surround the outside of the display panel,
wherein the frame comprises:
a base member;
an upper coating layer coated on the upper part of the base member;
a lower coating layer coated on the lower surface of the base member,

2. The display apparatus according to claim 1, wherein the frame further comprises a primer layer provided between the base member and the upper coating layer.

3. The display apparatus according to claim 2, wherein the frame further comprises a pre-treatment layer provided between the base member and the primer layer.

4. The display apparatus according to claim 1, wherein the friction coefficient of the lower coating layer is less than 0.3.

5. The display apparatus according to claim 1, wherein the upper coating layer is acrylic.

6. The display apparatus according to claim 1, wherein the lower coating layer is at least one selected from a group of acrylic resin, epoxy, polyester, and urethane.

7. The display apparatus according to claim 1, wherein the pre-treatment layer is at least one selected from a group of silicon oxide (SiO₂), zirconium oxide (ZrO₂), and chromium containing coating.

8. The display apparatus according to claim 1, wherein the base member is at least one selected from a group of stainless steel, aluminum, and metallic coated metal.

9. The display apparatus according to claim 8, wherein the metallic coated metal is at least one selected from a group of zinc (Zn), zinc-nickel (Zn—Ni), nickel (Ni), aluminum (Al), tin (Sn), and tin-zinc (Sn—Zn).

10. The display apparatus according to claim 1, wherein the frame is a middle front coupled to surround the lower outer surface of the display panel.

11. A manufacturing method of a display apparatus comprising a display panel configured to display an image, a frame provided on the outside of the display panel, the manufacturing method comprises:
coating an upper coating layer and a lower coating layer on the upper part and lower part of a base member;
slitting to cut the coated base member at predetermined intervals;
painting the cut surface of the base member on which slitting was performed;
drying the base member.

12. The manufacturing method according to claim 11, wherein the coating comprises coating a pre-treatment layer on the upper surface of the base member, coating a primer layer on the upper surface of the pre-treatment layer, coating the upper coating layer on the upper surface of the primer layer and coating the lower coating layer on the lower surface of the base member.

13. The manufacturing method according to claim 12, wherein the upper coating layer and the lower coating layer are coated at the same time.

14. The manufacturing method according to claim 11, wherein the friction coefficient of the lower coating layer is less than 0.3.
